(19) United States
(12) Patent Application Publication
(10) Pub. No.: US 2020/0340883 A1
(43) Pub. Date: Oct. 29, 2020

(54) THERMO-MECHANICAL FATIGUE SYSTEM FOR STATIC COMPONENTS

(71) Applicant: Rolls-Royce plc, London (GB)

(72) Inventors: Alexander Wong, London (GB); Steven Hillier, London (GB); Michael J. Whittle, London (GB)

(21) Appl. No.: 16/394,648

(22) Filed: Apr. 25, 2019

(51) Int. Cl. G01M 15/14; H04N 5/33; G01N 25/72; G01J 5/00; G01J 5/08; G01J 5/06

(52) U.S. Cl. CPC G01M 15/14; H04N 5/33; G01N 25/72; G01J 5/0088; G01J 2005/063; G01J 5/0821; G01J 5/061; G01J 2005/0077; G01J 5/0896

(57) ABSTRACT

According to an aspect of this disclosure, a system of applying thermal loads may include at least one laser module, and a plurality of optical components fixed to the at least one laser module and directing a plurality of laser beams from the plurality of optical components towards a surface. Further, the plurality of laser beams apply radiative heating to the surface in accordance with the system. The system also includes at least one infrared camera measuring thermal conditions of the surface, and a controller coordinating operation of the at least one laser module and the at least one infrared camera.

### FIELD OF THE DISCLOSURE

The present disclosure relates generally to gas turbine engines, and more specifically to testing of gas turbine engine components.

### BACKGROUND

Gas turbine engines are used to power aircraft, watercraft, power generators, and the like. Gas turbine engines typically include a compressor, a combustor, and a turbine. The compressor compresses air drawn into the engine and delivers high pressure air to the combustor. In the combustor, fuel is mixed with the high pressure air and is ignited. Products of the combustion reaction in the combustor are directed into the turbine where work is extracted to drive the compressor and, sometimes, an output shaft. Left-over products of the combustion are exhausted out of the turbine and may provide thrust in some applications.

Compressors and turbines typically include alternating stages of static vane assemblies and rotating wheel assemblies. The rotating wheel assemblies include disks carrying blades around their outer edges. When the rotating wheel assemblies turn, gas is propelled along a path through the gas turbine engine.

Some components positioned in the turbine may be exposed to high temperatures from products of the combustion reaction in the combustor. Such components may be made from materials that have different characteristics and that react differently when exposed to thermal stress, mechanical stress, and/or combinations thereof. Due to differing coefficients of thermal expansion and other physical qualities of the materials forming such components, these components experience failure at different rates, according to differing principles, and in response to varying thermal and mechanical loads uniquely experienced during operation of the gas turbine engine.

It may be desired to test components of gas turbine engines before production and deployment of these turbines and the components thereof. Conventional testing methods include mounting a full-scale turbine and operating same at, or near, full power and speed. Alternatively, furnaces, blowtorches, or resistive heaters are used as heating and cooling methods that approximate the conditions certain components experience during operation of a turbine. Testing with a full-scale turbine is expensive and presents challenges with respect to observing and measuring the components being tested because sensor placement within the full-scale turbine may be difficult and/or because deconstruction of the full-scale turbine for removal of tested components is time consuming and may give rise to inaccuracies in gathered data. Testing methods that do not involve insertion of a component into a full-scale turbine, such as furnace heating, also present challenges to gathering accurate data because replication of the thermal and mechanical stresses developed during operation of a turbine are difficult to reliably and precisely reproduce.

Conventional testing rigs that are able to replicate in-engine thermal conditions on static components often experience the following challenges: very high operating cost (typically from fuel), inability to cycle heating and cooling according to intervals and with ramp-up/down rates that practically demonstrate the target thermo-mechanical life of a component, and an inability to replicate representative temperatures across all features. Design and analysis methods and material characterizations for metallic turbine static components are sufficiently mature that the first empirical evaluation of new designs is often performed during full-scale engine bench tests. Small-scale rig testing of individual components is less frequently justified for new metal components.

Development of non-metallic components capable of withstanding the high temperatures and mechanical stresses of turbine operation is important for progressing numerous fields that utilize gas turbine engines, especially aircraft. Therefore, systems and/or methods for testing components with high fidelity, increased speed, and decreased expense represent an improvement in the art.

The description provided in the background section should not be assumed to be prior art merely because it is mentioned in or associated with the background section. The background section may include information that describes one or more aspects of the subject technology.

### SUMMARY

The present disclosure may comprise one or more of the following features and combinations thereof.

According to an aspect of this disclosure, a system of applying thermal loads may include at least one laser module, and a plurality of optical components fixed to the at least one laser module and directing a plurality of laser beams from the plurality of optical components towards a surface. Further, the plurality of laser beams apply radiative heating to the surface in accordance with the system. The system also includes at least one infrared camera measuring thermal conditions of the surface, and a controller coordinating operation of the at least one laser module and the at least one infrared camera.

In some embodiments of the system according to this aspect, the controller turns off the at least one laser module when the at least one infrared camera measures the thermal conditions of the surface. Further, according to this embodiment, the surface is disposed on a component of a gas turbine engine and thermal conditions of the surface are cycled. In this system the plurality of optical components direct the plurality of laser beams towards the surface according to a pattern mapped across the surface. In embodiments, the pattern is a three-dimensional pattern of loci on the surface. Also in examples of this system, the three-dimensional pattern of loci on the surface corresponds to the plurality of laser beams. In further example embodiments, a plurality of optical waveguides correspond to the plurality of optical components, and the plurality of optical waveguides and the plurality of optical components are remote from the surface. The system may also include the plurality of optical waveguides and the corresponding optical components being mounted in a guide structure that directs the laser beams according to the three-dimension pattern of loci on the surface.

According to another aspect of the present disclosure, a method of applying thermal loads includes coupling a plurality of fiber optic waveguides to a plurality of laser modules, mapping a plurality of points along a turbine component, arranging the plurality of fiber optic waveguides with an apparatus, directing light from the plurality of fiber optic waveguides onto the surface wherein the plurality of fiber optic waveguides correspond to the plurality of points, and thermally loading the turbine component by radiative heating according to the mapped plurality of points.

In example embodiments of this method the mapping of the plurality of points determines a three-dimensional map of a surface of the turbine component. Also, examples may include measuring a thermal load on the turbine component with an infrared thermal camera remote from the turbine component. Still further, the method may include the plurality of fiber optic waveguides being remote from the turbine component. According to this method, a controller further performs steps of controlling the plurality of laser modules and the infrared thermal camera, and coordinating the plurality of laser modules to turn off when the infrared thermal camera measures the thermal load on the turbine component. In further examples, the thermal loading is performed cyclically over time. Additionally, the method may include a controller adjusting the thermal loading by individually adjusting each of the plurality of laser modules to manipulate the thermal loading at each of the mapped plurality of points.

According to yet another aspect of the present disclosure a system of guiding laser beams includes a bitmapped surface, a plurality of fibers disposed remote from the surface, a plurality of laser modules supplying light to the plurality of fibers wherein the plurality of fibers direct the light towards the surface, a guide structure mounting the plurality of fibers to direct the light in correspondence with the mapped array on the surface, and a controller for operating each of the plurality of laser modules.

In example embodiments of this system, the plurality of fibers differ in length as determined by the bitmapped surface. In further examples, the plurality of laser modules are driven individually by the controller to develop thermal boundary conditions on the surface. Additionally, in examples, the plurality of laser modules are turned off when the controller instructs an infrared thermal camera to observe the temperature of the surface. Further still, the plurality of fibers and the infrared thermal camera have a clear line of sight to the surface, in example embodiments.

These and other features of the present disclosure will become more apparent from the following description of the illustrative embodiments.

### BRIEF DESCRIPTION OF THE DRAWINGS

FIG. 1 is a block diagram of the system and/or method of directing laser light through fiber optics towards a target surface or turbine component;

FIG. 2 illustrates a turbine component with an array of loci across the surface thereof and corresponding to laser beams directed towards said surface;

FIG. 3 illustrates a square array of loci for positioning laser beams on the surface of the turbine component, according to an example;

FIG. 4 illustrates a hexagonal array of loci for positioning laser beams on the surface of the turbine component, according to an example;

FIG. 5 is a block diagram of the control system and sub-systems according to an example of the system and/or method;

FIG. 6 illustrates an arrangement of one or more guide structures with optical fibers passing therethrough for applying laser radiation to the turbine component(s);

FIG. 7 illustrates an arrangement of one or more guide structures with optical fibers passing therethrough for applying laser radiation to the turbine component(s); and

FIG. 8 illustrates an arrangement of one or more guide structures with optical fibers passing therethrough for applying laser radiation to the turbine component(s).

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION OF THE DRAWINGS

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

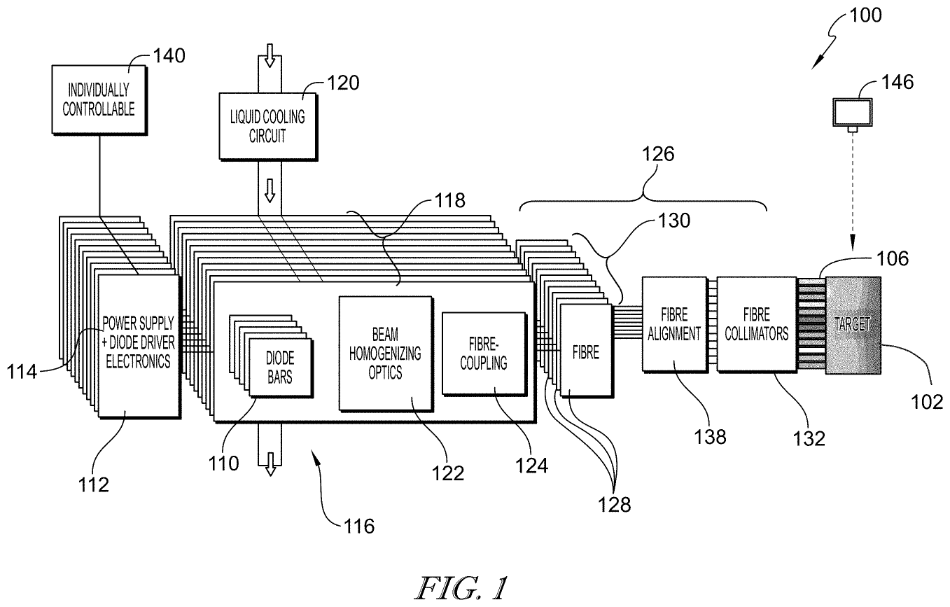

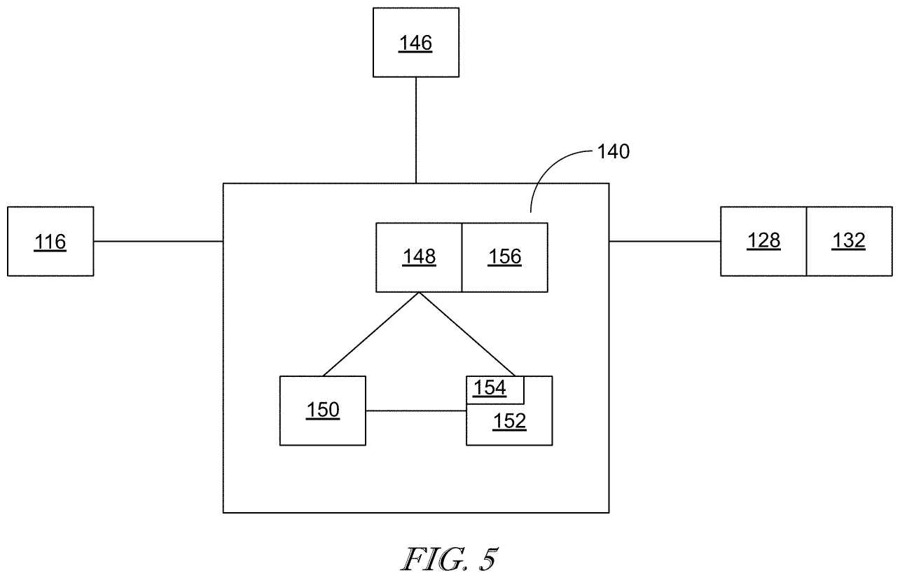

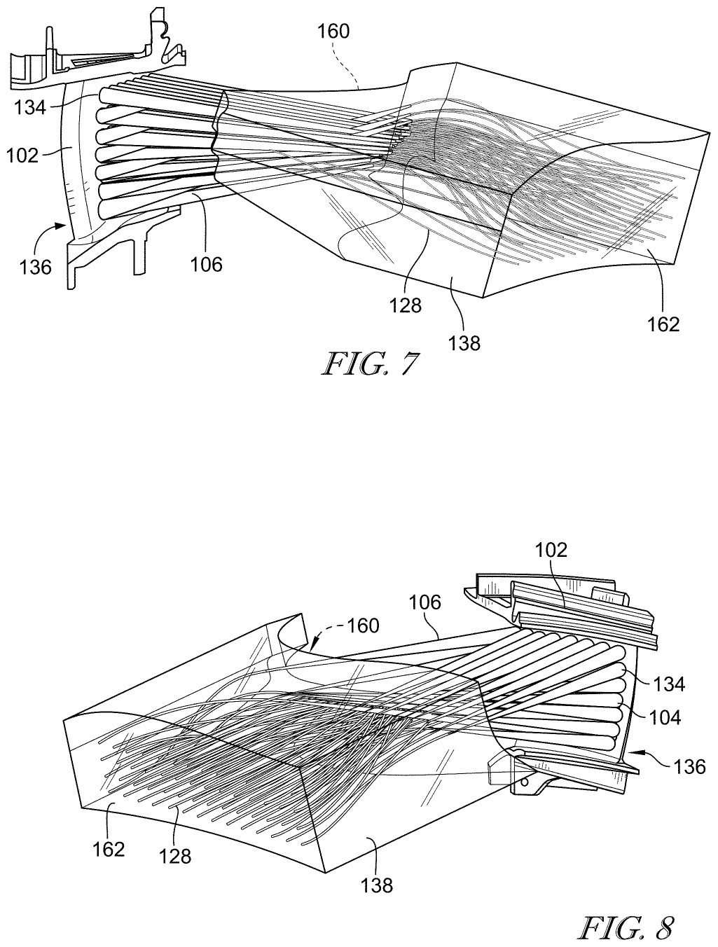

The present disclosure, with reference to FIGS. 1-8, describes a system and method 100 of applying thermo-mechanical stress to one or more components 102 of gas turbine engines. The system 100 comprises heating and cooling as well as instrumentation and control processes that impose predetermined temperatures upon the component(s) 102. The component(s) 102 may be full-scale components disposed within a testing rig. Further, the predetermined temperatures applied to the component(s) 102 may be predicted in order to accurately replicate a thermal environment that is representative of conditions the one or more components 102 would otherwise experience only during full-scale engine operation. However, according to example embodiments, the component(s) 102 may be scaled down, scaled according to experimental parameters (e.g., components for prototype engines, engines currently undergoing development, newly designed engine components for existing engines, and/or other suitable design and testing conditions), and/or manufactured according to specifications desirable for testing purposes.

Examples of the turbine component(s) 102 for which the system 100 is utilized include nozzle guide vanes, seal segments, and/or other suitable turbine components for which it is desirable to replicate thermal and mechanical fatigue conditions without conducting full-scale operational testing of a turbine. Particularly, the system 100 is applicable to testing of turbine components that are cooled during operation, such as by gas path features including film cooling. The system 100 is particularly practical for components that are not easily monitored and/or removed for observation from a turbine after full-scale operation thereof on a conventional testing rig.

The system 100 may be used for testing new materials and/or geometries in static, hot-end gas path components. Examples of the component(s) 102 for testing are additive layer manufacturing components, ceramic matrix composites (CMC) components, cast-bond components, seal segments, nozzle guide vanes (as shown in the FIGS.), combustor tile components, and/or any other components for which thermo-mechanical fatigue is an important characteristic. The system 100 may further be of interest for facilitating the structural analysis and life span testing for components and/or materials for which other testing methods are inadequately developed and/or cost prohibitive.

The system 100 also facilitates ramping of the thermal conditions from ambient to operational conditions at rates that accurately represent the analogous thermal changes during extended and/or repeated engine operation. This enables cyclical testing of the component(s) 102. Cyclical testing permits experimental verification of the thermo-mechanical fatigue use-life of components by simulating the repeated heating and cooling encountered during typical engine operation. Further, cyclical testing of the component(s) 102 according to the system 100 may be of interest because same may be performed ahead of full-scale engine testing and at significantly lower expense. The system 100 is less expensive to operate as compared with similar burner-based testing rigs, which heat components through combustion, making longer and more representative testing feasible.

Referring now to FIG. 1, a block diagram of the system and/or method 100 is illustrated. The system 100 develops a plurality of lasers modules 116. The lasers modules 116 comprise one or more diode bars 110. Diode bars are high-powered semiconductor lasers containing one or more arrays of broad-area emitters (i.e. laser diodes). Embodiments are also contemplated wherein the laser modules 116 comprise vertical-cavity surface-emitting lasers (VCSEL), solid-state lasers, metal-vapor lasers, other semiconductor lasers, and/or another suitable source of laser light, The diode bars 110 are driven by associated diode driver circuits 112 operatively coupled with one or more power sources 114. In an example embodiment, the power source(s) 114 are relatively low voltage but supply high current to the one or more diode bars 110 in order to generate high radiance laser beams 106. The one or more arrays of laser diodes are mounted in an arrangement forming an example one of the diode bars 110, and the diode bars 110 are then arranged within the plurality of laser modules 116. The laser modules 116, in turn, are configured to form an array of laser modules 118.

A liquid cooling circuit 120 is thermally coupled to each of the one or more laser modules 116 in the array of laser modules 118 to provide thermal management thereof. The diode bars 110 often have a narrow operating temperature window of, for example, 30-35° Celsius. The liquid cooling circuit 120 maintains optimal operating temperatures during continuous and/or repeated activation of the diode bars 110 by the diode driver circuits 112.

Broad-area emitters typically emit high power laser beams with reduced focus. Therefore, beam-homogenizing optical elements 122 are optically coupled with the one or more laser modules 116 to gather and focus the light emitted by the laser modules 116. The beam-homogenizing optical elements 122 are aligned with one or more optical couplers 124. The optical coupler(s) 124 redirect the emitted light into a plurality of waveguides 126. The waveguides 126 are a plurality of strands of glass or polymer fibers 128 formed into one or more fiber optic cables 130, although other optical waveguides formed from differing materials may be utilized according to system specifications, size, flexibility, and/or manufacturability. Further, example embodiments omit the plurality of optical waveguides 126. The one or more fiber optic cables 130 traverse a space between the laser module(s) 116 and a location proximal the component 102 subject to testing. The individual fibers 128 terminate with corresponding fiber tip optical elements 132. The laser module(s) 116, fibers 128, and other components described hereinabove are modular and may be replaced and/or interchanged as desired so as to customize the power and wavelength of the laser module(s) 116.

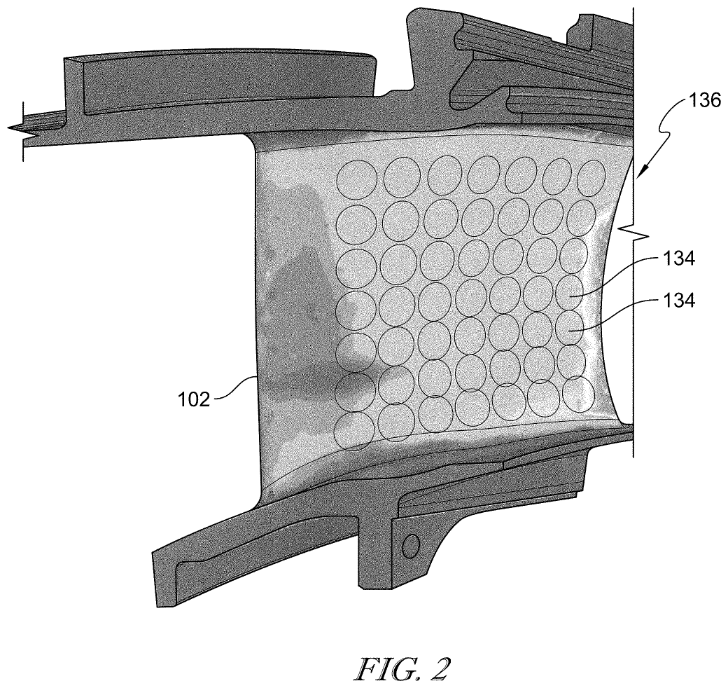

The fiber tip optical elements 132 are diverging concave lenses, light collimators, and/or other optical elements suitable for further focusing and projecting light carried by each of the individual fibers 128 onto a particular locus 134 of the subject component 102. The fiber tip optical elements 132 focus the laser light to a selected diameter in order to heat the component 102 undergoing testing. Through coordinated control the fiber tip optical elements 132 project the laser light from the fibers 128 through free space onto the target component 102 in an array of loci 136 arranged along a surface 104 of the component 102, as shown in FIG. 2.

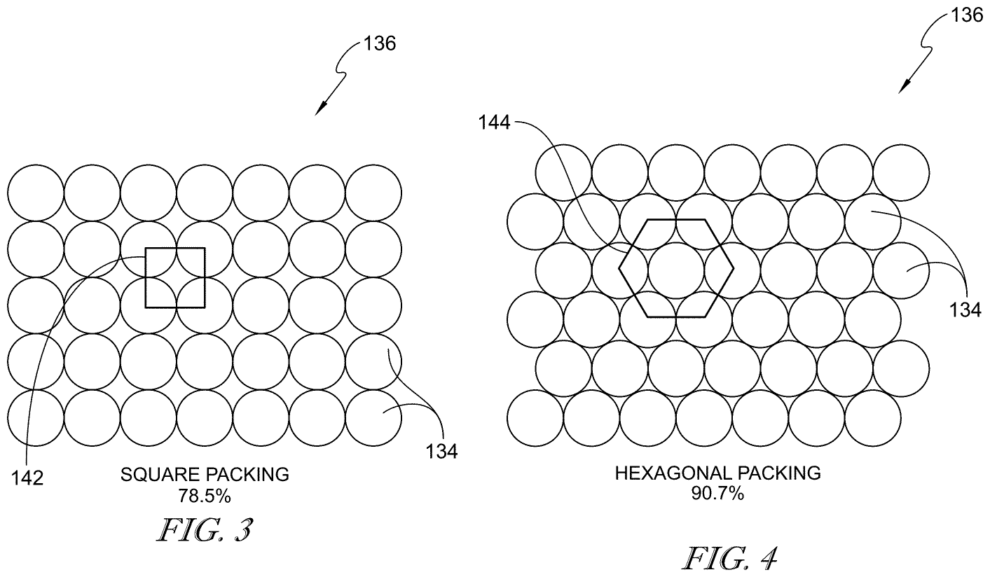

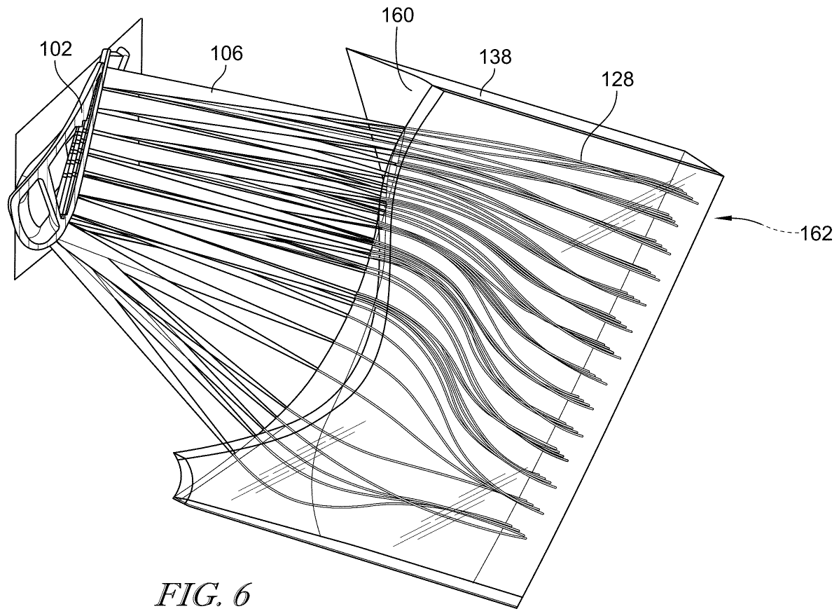

In example embodiments, the one or more fiber optic cables 130 pass through and are mounted within one or more guide structures or apparatuses 138 (detailed hereinbelow with respect to FIGS. 6, 7, and 8) that fix the fiber optic cable(s) 130 in a desired pattern across the target component 102 so that the array of loci 136 is accurately arranged along the entire surface area that is to be heated. The one or more guide structures 138 may be stationary or may provide additional control by manipulating the one or more fiber optic cables 130 and/or the individual fibers 128 relative the surface of the component 102. FIG. 2 illustrates a high pressure nozzle guide vane with the array of loci 136 having a 7 millimeter beam size and developing a desired heat flux across the surface of the target component 102. The array of loci 136 may be arranged along the surface of the component 102 according to a square array loci pattern 142 (shown in FIG. 3) or a hexagonal array loci pattern 144 (shown in FIG. 4), each formed from a repeated circular locus. The square array loci pattern 142 covers about 78.5% of the surface area of the target component 102 while the hexagonal array loci pattern 144 covers about 90.7% of the surface area of the component 102 being tested.

As noted hereinabove, the one or more guide structures 138 position the individual fibers 128 and the associated fiber tip optical elements 132 in position to project a desired pattern. The square array loci pattern 142 is projected on the nozzle guide vane component 102, as shown in FIG. 2. The generation of stresses in cooled components, such as by film cooling, is often characterized by thermal strain between cooled material (e.g., proximal a cooling hole) and thermally loaded material (e.g., further from a cooling hole). The array of loci 136 characteristic of the system 100 is, therefore, capable of accurately replicating the stress and temperature combinations experience by components at turbine features disposed within or along the gas path because cooling mechanisms may be operated within the component(s) 102 during testing by the system 100 without interrupting the radiative heating mechanism leveraged thereby.

The heating mechanism engaged by the system 100 is radiative (i.e., the electromagnetic radiation emitted by the laser module(s) 116 is absorbed by the target component 102 resulting in the radiative transfer of heat to said component). This radiative heating mechanism is substituted for convective heat transfer mechanisms present during full-scale engine operation or conventional engine testing rigs. Customizable arrangement of the array of individually addressable and controllable laser modules 116 facilitates spatially varying heat transfer to the target component 102. Accordingly, the system 100 develops a bitmapped distribution of heat flux applied to the component 102, in contrast with fluid temperature distributions resulting from the heat transfer co-efficient of the material during in-engine operation and/or testing. The component(s) 102 may be cooled by providing coolant flow through a cooling mechanism of the component(s) 102, and this coolant flow may be utilized by the system 100 to generate local thermal strains proximal features of the cooling mechanism. In examples, cycling of the coolant flow is synchronized with a testing profile such that coolant temperatures and/or mass flow rates are reduced in correlation with reductions in the radiative heat applied by the system 100. These features together assist in providing reliable reproduction of in-engine thermomechanical stresses.

The system 100 contemplated hereinthroughout develops a higher-fidelity thermal boundary condition within the component materials. The system 100 employs real-time measurement of the external temperature distribution achieved by monitoring the surface 104 of the target component 102 with one or more infrared (IR) thermography cameras or pyrometers 146. To increase precision and accuracy of temperature observations by the one or more IR cameras 146, the component 102 is coated with constant emissivity paint, e.g., Rolls-Royce™ HE-23 black thermal paint, which is stable over a wide temperature range up to 1300° Celsius, or another suitable paint capable of producing a stable emissivity value and accurate temperature measurement for the duration of thermal cycling.

The laser module(s) 116 and the fiber optic cable(s) 130 are operated by a control system 140 comprising three control sub-systems. A first control sub-system 148 is a closed-loop process for heating and cooling that interfaces with the controlled hardware, e.g., the laser diode driver circuits 112, valves, regulators, and sensor inputs such as temperature measurements from the one or more IR cameras 146. In an example embodiment, a cooling mechanism of the component(s) 102 utilizes a coolant fluid such as pressurized air. Valves and regulators are controlled, in this example, by the control system 140, to manipulate the mass flow rate, pressure, and/or temperature of the coolant fluid to adjust the cooling effect of a cooling mechanism within the component(s) 102. Elements of the cooling mechanism are controlled, for example by the first sub-control system 148, in coordination with the heating supplied by the system 100. In an example embodiment, the first control sub-system 148 includes proportional integral derivative (PID) controllers associated with each of the fibers 128 and/or the loci 134. A second control sub-system 150 is an analytical process that records, analyzes, and coordinates a high-level testing strategy. The second control sub-system 150 includes, for example, tracking of test cycles, analysis of temperature and mechanical fatigue readings over time, control of sensors for gathering thermo-mechanical fatigue data (including the IR cameras 146), and control of actuators and/or other components for imposing mechanical stress on the subject component(s) 102. A third control sub-system 152 comprises data logging and storage as well as a user interface 154.

Data logging and tracking of test cycles may have significant overlap and the processing, storage, and analysis of testing parameters and observations may be suitably performed by the second or third control sub-systems 150, 152 dependent upon particular applications and implementations of the system 100. In example embodiments, the user interface 154 includes one or more graphical user interfaces and input/output computer peripherals for presenting data to a user/operator and/or accepting inputs regarding testing protocols, configuration changes, etc. from a user/operator. Further, each of the loci 134 have corresponding laser sources, IR camera feedback, and target temperatures in association with particular testing protocols. According to an example embodiment of the system 100, these elements may be analogous to single thermocouples, a single thermocouple control, and a target temperature associated therewith embodied within a conventional thermomechanical fatigue testing rig.

In an example embodiment, the control system 140 includes a model predictive control system 156 stored in a memory module and executed by a processor module. The model predictive control system 156 is a separate control sub-system or may be housed within one of the control sub-systems 148, 150, 152. The model predictive control system 156 leverages a numerical model of the system 100, which allows a forward prediction of system outputs for select control inputs. By comparison, one or more PID controller(s), as discussed hereinabove as part of the first control sub-system 148, observes the current parameters of the system 100 and possesses a memory of the past system parameters. However, the model predictive control system 156 addresses the heating and cooling of the target component 102 as an optimization problem. In an example, the model predictive control system 156 is developed from currently available models of finite element thermomechanical analysis simulating engine boundary conditions. Mechanical loading may be applied in addition to the thermal boundary conditions to more accurately recreate the stress state experienced by the component(s) 102 during engine operating conditions. The basis for the model predictive control system 156 may be condensed into a numerical approximation of the conventional model until the numerical approximation is suitable for the control system 140. Further, the model predictive control system includes, for example, ray-tracing and/or view factor calculations of the radiative energy supplied by the laser modules 116 and directed out of the fiber tip optical elements 132.

The IR thermal camera(s) 146 (or pyrometers) can provide thermal center improvements because the IR cameras 146 are non-contact, quickly responsive, and render fast readings (e.g., example IR cameras are capable of more than fifty measurements per second). Further, the IR thermal camera(s) 146 develop a high-resolution map of surface temperatures on the target component(s) 102. Typical IR cameras for industrial applications have resolutions of 640×480 or higher; and, therefore, capture over 300,000 individual measurement points. Additionally, the quick responsiveness of the IR cameras 146 in combination with the controllability of the laser module(s) 116 enables the control system 140 to turn the laser module(s) 116 off and activate the IR cameras 146 during a short time period while the laser module(s) 116 are not projecting radiation towards the component(s) 102. Gathering of temperature readings while the heat source is turned off allows for more accurate observation of the temperatures and thermal boundaries developed across the surface 104 of the component 102 being tested. This is a notable attribute as compared with conventional blowtorch-type heaters, resistive elements, and/or furnaces that may impart some heating to the thermal sensors that is additive to the thermal conditions present at a measured surface of a component undergoing testing. Additionally, conventional furnaces or blowtorch-type heaters typically require expensive insulated housing and insulation of other associated equipment, but the present system and/or method 100 may be implemented with less insulation because of the directed nature of the laser beams 106 (FIG. 1). The directed laser beams 106 of the system 100 also decrease the thermal load experienced by the testing rig and other hardware proximal the target component(s) 102, particularly as compared with conventional furnace testing configurations.

Emissivity of surfaces of the tested component(s) 102 are important for proffering precise temperature detection. Emissivity is affected by material type, surface temperature, viewing angle, and/or surface condition. Reliability and accuracy are increased when the one or more IR cameras 146 have a direct line of sight to each of the loci 134 on the surface of the component(s) 102. Accurate temperature readings may be time dependent due to the development of surface oxides during exposure of the component(s) 102 to heat. Pre-oxidizing, such as by high temperature pre-aging in an oxidizing environment, is a technique that deliberately manipulates the surface condition to reach a stable emissivity, but may generate an undue material fatigue over time or be unavailable for particular material types such as SiC (i.e., silicon carbide).

The control system 140 described hereinabove results in numerous features. The individual addressability of each of the laser module(s) 116 and the fibers 128 (thereby controlling temperature applied to each locus of the array of loci 136) improves transient control of temperatures, due to the very fast and precise control of each, individual heat source. The transient control of temperatures is further improved by the rapid feedback and measurement system facilitated by the system 100; and, particularly, the model predictive control system 156. Further, measurement of a two dimensional bitmap of temperatures allows the control system 140 to manipulate two dimensional temperature contour. Moreover, the closed-loop control system 140 compensates for a non-linearity in output from the laser module(s) 116 resulting from energy absorbed by the testing rig support structure. An example testing rig for use with the system 100 has a pressure vessel with high reflectivity surfaces such that heat loads experienced by the supportive rig elements are minimized. According to this example embodiment, energy reflected back into the component(s) 102 is accounted for by the control system 140 while said control system 140 continues targeting a particularly selected temperature. Further example embodiments combine non-uniform heating sources, such as resistive heating elements super-imposed over the presently described laser heating system 100. In examples, the laser beams 106 have relatively low dispersion such that the laser module(s) 116 are relatively remote from the target component(s) 102 and the surfaces of the target component(s) 102 are directly viewable or viewable with minimal obstruction.

Referring now to FIGS. 6, 7, and 8, an arrangement of the one or more guide structures 138 and the fibers 128 are shown applying the laser radiation to the component(s) 102 spaced approximately 100 millimeters away from the loci 134 disposed on the surface 104 of said component(s) 102. The arrangement of the guide structure(s) 138 and fibers 128 is developed by first mapping the array of loci 136 along the surface 104 of the component(s) 102. In the examples of FIGS. 6-8, the loci 134 are approximately 7 millimeters. Then, center points of each of the loci 134 are projected out and away from the surface of the component(s) 102 approximately 100 millimeters, although the projection depth of the lasers beams 106 may be varied with associated differences in focus of the laser beams 106. This defines the position of the fiber tip optical element 132 (not shown in FIGS. 6-8) for each of the fibers 128. Each of the fiber tip optical elements 132 projects one of the laser beams 106. The beams 106 shown here have a divergence of about 2°. Often times, it is not desirable to cross the beams 106, so the presently described method may further check that the 2° beam divergence results in a tightly arranged, but not overlapping array. In example embodiments, some overlapping of the beams 106 is desirable such as to combine the square array loci pattern 142 (shown in FIG. 3) with the hexagonal array loci pattern 144 (shown in FIG. 4). In this example embodiment, one of the loci patterns supplies global heating while the other pattern develops localized additional heat flux. Beam crossing and combinations of array loci patterns 142, 144 may result in surface coverage significantly greater than 90%.

Additionally, it is not desirable for the fibers 128 to cross or overlap within the guide structure 138. Therefore, this method of developing the fiber positioning utilizes different lengths of fiber optics such that the fibers 128 may be bent and turned to approach a projection surface 160, which mirrors the surface 104 of the component(s) 102, from which the laser beams 106 are emitted. Flexibility of the fibers 128, or non-rigidity of same, enables curved configurations within the guide structure(s) 138 that assist in the mapping of the three-dimensional surface 104 of the target component(s) 102.

Opposite the projection surface 160 of the guide structure 138 is a fiber array surface 162 whereat the individual fibers 128 are organized into an array corresponding to the laser module(s) 116 providing light to each of the fibers 128, as discussed hereinabove. The collimation and minimal divergence of the laser beams 106 facilities the disposition of guide structure(s) 138 and the projection surface 160 remote from the target component(s) 102. This provides better access for measuring temperature by the IR cameras 146, particularly as compared with conventional blowtorch or radiant lamp heating arrangements. According to this example arrangement of the fibers 128, the guide structure(s) 138 and the fibers 128 together map a plane or simple surface (the fiber array surface 162) onto the complex, three-dimensional surfaces of the component(s) 102 undergoing testing.

This system 100 may be desirable when a single source supplies all laser light that is projected onto the component(s) 102 and/or when it is desirable to interweave a number of different sources being carried by numerous of the fibers 128 such that all of the sources may be simultaneously or sequentially used during operation of the system 100. For example, lasers providing differing radiative or heating profiles may be used during different stages of a testing protocol such that it is desirable for both sources to be transmitted by the fibers 128 passing through the guide structure(s) 138.

Example embodiments of the guide structure(s) 138 shown in FIGS. 6, 7, and 8, also include water/fluid cooling channels and mounting and cooling passages for the IR cameras 146. Additive layer manufacturing techniques, and/or other suitable manufacturing techniques, are utilized to develop customized and complex channels/passages through the guide structure(s) 138.

The system and/or method 100 illustrated by FIGS. 6-8 includes heating of the airfoil element of the component(s) 102 (here a nozzle guide vane). The platform of a nozzle guide vane (or e.g., a blade root, rotor disk surface, etc.) is also subjected to thermo-mechanical stress and is heated in certain embodiments. Additional guide structures may be arranged from varying angles to direct laser beams towards other surfaces of the subject component(s) 102. Heating of these surfaces also may be included within the guide structure(s) 138 as described hereinabove.

The embodiment(s) detailed hereinabove may be combined in full or in part, with any alternative embodiment(s) described.

In the foregoing description, numerous specific details, examples, and scenarios are set forth in order to provide a more thorough understanding of the present disclosure. It will be appreciated, however, that embodiments of the disclosure may be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described may include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to effect such feature, structure, or characteristic in connection with other embodiments whether or not explicitly indicated.

Embodiments in accordance with the disclosure may be implemented in hardware, firmware, software, or any combination thereof. Embodiments may also be implemented as instructions stored using one or more machine-readable media, which may be read and executed by one or more processors. A machine-readable medium may include any mechanism for storing or transmitting information in a form readable by a machine. For example, a machine-readable medium may include any suitable form of volatile or non-volatile memory.

Modules, steps, processes, controls, and the like defined herein are defined as such for ease of discussion, and are not intended to imply that any specific implementation details are required. For example, any of the described modules and/or data structures may be combined or divided into sub-modules, sub-processes or other units of computer code or data as may be required by a particular design or implementation.

In the drawings, specific arrangements or orderings of schematic elements may be shown for ease of description. However, the specific ordering or arrangement of such elements is not meant to imply that a particular order or sequence of processing, or separation of processes, is required in all embodiments. In general, schematic elements used to represent instruction blocks or modules may be implemented using any suitable form of machine-readable instruction, and each such instruction may be implemented using any suitable programming language, library, application programming interface (API), and/or other software development tools or frameworks. Similarly, schematic elements used to represent data or information may be implemented using any suitable electronic arrangement or data structure. Further, some connections, relationships, or associations between elements may be simplified or not shown in the drawings so as not to obscure the disclosure.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A system of applying thermal loads, comprising:
at least one laser module;
a plurality of optical components fixed to the at least one laser module and directing a plurality of laser beams from the plurality of optical components towards a surface;
wherein the plurality of laser beams apply radiative heating to the surface;
at least one infrared camera measuring thermal conditions of the surface; and
a controller coordinating operation of the at least one laser module and the at least one infrared camera.

2. The system of claim 1, wherein the controller turns off the at least one laser module when the at least one infrared camera measures the thermal conditions of the surface.

3. The system of claim 2, wherein the surface is on a component of a gas turbine engine and thermal conditions of the surface are cycled.

4. The system of claim 1, wherein the plurality of optical components direct the plurality of laser beams towards the surface according to a pattern mapped across the surface.

5. The system of claim 4, wherein the pattern is a three-dimensional pattern of loci on the surface.

6. The system of claim 5, wherein the three-dimensional pattern of loci on the surface corresponds to the plurality of laser beams.

7. The system of claim 6, wherein a plurality of optical waveguides correspond to the plurality of optical components; and
wherein the plurality of optical waveguides and the plurality of optical components are remote from the surface.

8. The system of claim 7, wherein the plurality of optical waveguides and the corresponding optical components are mounted in a guide structure that directs the laser beams according to the three-dimension pattern of loci on the surface.

9. A method of applying thermal loads, comprising:
coupling a plurality of fiber optic waveguides to a plurality of laser modules;
mapping a plurality of points along a turbine component;
arranging the plurality of fiber optic waveguides with an apparatus;
directing light from the plurality of fiber optic waveguides onto the surface;
wherein the plurality of fiber optic waveguides correspond to the plurality of points; and
thermally loading the turbine component by radiative heating according to the mapped plurality of points.

10. The method of claim 9, wherein the mapping of the plurality of points determines a three-dimensional map of a surface of the turbine component.

11. The method of claim 9, further comprising:
measuring a thermal load on the turbine component with an infrared thermal camera remote from the turbine component.

12. The method of claim 11, wherein the plurality of fiber optic waveguides are remote from the turbine component.

13. The method of claim 11, wherein a controller further performs steps of:
controlling the plurality of laser modules and the infrared thermal camera; and
coordinating the plurality of laser modules to turn off when the infrared thermal camera measures the thermal load on the turbine component.

14. The method of claim 9, wherein the thermal loading is performed cyclically over time.

15. The method of claim 9, wherein a controller adjusts the thermal loading by individually adjusting each of the plurality of laser modules to manipulate the thermal loading at each of the mapped plurality of points.

16. A system of guiding laser light, comprising:
a bitmapped surface;
a plurality of fibers disposed remote from the surface;
a plurality of laser modules supplying light to the plurality of fibers;
wherein the plurality of fibers direct the light towards the surface;
a guide structure mounting the plurality of fibers to direct the light in correspondence with the bitmapped surface;
a controller for operating each of the plurality of laser modules.

17. The system of claim 16, wherein the plurality of fibers differ in length as determined by the bitmapped surface.

18. The system of claim 17, wherein the plurality of laser modules are driven individually by the controller to develop thermal boundary conditions on the surface.

19. The system of claim 18, wherein the plurality of laser modules are turned off when the controller instructs an infrared thermal camera to observe the temperature of the surface.

20. The system of claim 18, wherein the plurality of fibers and the infrared thermal camera have a clear line of sight to the surface.
